(19) United States
(12) Patent Application Publication
(10) Pub. No.: US 2023/0042234 A1
(43) Pub. Date: Feb. 9, 2023

(54) METHOD FOR TRAINING MODEL, DEVICE, AND STORAGE MEDIUM

(71) Applicant: BEIJING BAIDU NETCOM SCIENCE TECHNOLOGY CO., LTD., Beijing (CN)

(72) Inventors: Yangliu XU, Beijing (CN); Qunyi Xie, Beijing (CN); Yi Chen, Beijing (CN); Xiameng Qin, Beijing (CN); Chengquan Zhang, Beijing (CN); Kun Yao, Beijing (CN)

(21) Appl. No.: 17/972,253

(22) Filed: Oct. 24, 2022

(30) Foreign Application Priority Data
Oct. 26, 2021 (CN) 202111248583.6

(51) Int. Cl. G06N 3/08

(52) U.S. Cl. CPC G06N 3/08

(57) ABSTRACT

A method for training a model includes: obtaining a scene image, second actual characters in the scene image and a second construct image; obtaining first features and first recognition characters of characters obtained by performing character recognition on the scene image using the model to be trained; obtaining second features of characters obtained by performing character recognition on the second construct image using the training auxiliary model; and obtaining a character recognition model by adjusting model parameters of the model to be trained based on the first recognition characters, the second actual characters, the first features and the second features.

### CROSS-REFERENCE TO RELATED APPLICATION

This application claims priority to Chinese Patent Application No. 202111248583.6 filed on Oct. 26, 2021, the entire content of which is incorporated herein by reference.

### TECHNICAL FIELD

The disclosure relates to the field of artificial intelligence (AI) technology, in particular to the field of computer vision and deep learning technology, and can be applicable to scenarios such as optical character recognition (OCR).

### BACKGROUND

In recent years, OCR technology has been widely concerned and applied in various industries such as finance, transportation and education. Based on the OCR technology, electronic devices can translate character(s) in an image into computer recognizable character(s), to realize character recognition.

In addition, the existing AI technology has also been developed rapidly. The AI technology has been gradually introduced into character recognition scenarios. More and more people realize that using neural network models to realize character recognition can significantly improve the efficiency and accuracy of character recognition. Therefore, how to train neural network models for character recognition has become an urgent problem to be solved.

### SUMMARY

According to a first aspect of the disclosure, a method for training a model is provided. The method includes: obtaining a model to be trained and a training auxiliary model by training an initial neural network model based on a first construct image and first actual characters in the first construct image; obtaining a scene image, second actual characters in the scene image and a second construct image, in which characters in the second construct image are identical to the second actual characters; obtaining first features and first recognition characters of characters obtained by performing character recognition on the scene image using the model to be trained; obtaining second features of characters obtained by performing character recognition on the second construct image using the training auxiliary model; and obtaining a character recognition model by adjusting model parameters of the model to be trained based on the first recognition characters, the second actual characters, the first features and the second features.

According to a second aspect of the disclosure, a method for recognizing characters is provided. The method includes: obtaining an image to be recognized; and obtaining recognition characters by inputting the image to be recognized into a character recognition model, in which the character recognition model is a model trained based on the method of the first aspect of the disclosure.

According to a third aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is enabled to implement the method for training a model or the method for recognizing characters.

According to a fourth aspect of the disclosure, a non-transitory computer-readable storage medium storing computer instructions is provided. The computer instructions are configured to cause a computer to implement the method for training a model or the method for recognizing characters.

### BRIEF DESCRIPTION OF THE DRAWINGS

The drawings are used to better understand the solutions and do not constitute a limitation to the disclosure, in which:

FIG. 1 is a flowchart of a first method for training a model according to embodiments of the disclosure.

FIG. 2a is a first construct image according to embodiments of the disclosure.

FIG. 2b is a scene image according to embodiments of the disclosure.

FIG. 2c is a second construct image according to embodiments of the disclosure.

FIG. 3 is a flowchart of a second method for training a model according to embodiments of the disclosure.

FIG. 4a is a flowchart of a third method for training a model according to embodiments of the disclosure.

FIG. 4b is a schematic diagram of a training auxiliary model according to embodiments of the disclosure.

FIG. 5 is a flowchart of a fourth method for training a model according to embodiments of the disclosure.

FIG. 6a is a third construct image according to embodiments of the disclosure.

FIG. 6b is a fourth construct image according to embodiments of the disclosure.

FIG. 7 is a schematic diagram of a model to be trained and a training auxiliary model according to embodiments of the disclosure.

FIG. 8 is a flowchart of a method for recognizing characters according to embodiments of the disclosure.

FIG. 9 is a schematic diagram of a first apparatus for training a model according to embodiments of the disclosure.

FIG. 10 is a schematic diagram of a second apparatus for training a model according to embodiments of the disclosure.

FIG. 11 is a schematic diagram of a third apparatus for training a model according to embodiments of the disclosure.

FIG. 12 is a schematic diagram of a fourth apparatus for training a model according to embodiments of the disclosure.

FIG. 13 is a schematic diagram of an apparatus for recognizing characters according to embodiments of the disclosure.

FIG. 14 is a block diagram of an electronic device used to implement a method for training a model or a method for recognizing characters according to embodiments of the disclosure.

### DETAILED DESCRIPTION

The following describes embodiments of the disclosure with reference to the accompanying drawings, which includes various details of embodiments of the disclosure to facilitate understanding, and shall be considered merely exemplary. Therefore, those skilled in the art should recognize that various changes and modifications can be made to embodiments described herein without departing from the scope and spirit of the disclosure. For clarity and conciseness, descriptions of well-known functions and structures are omitted in the following description.

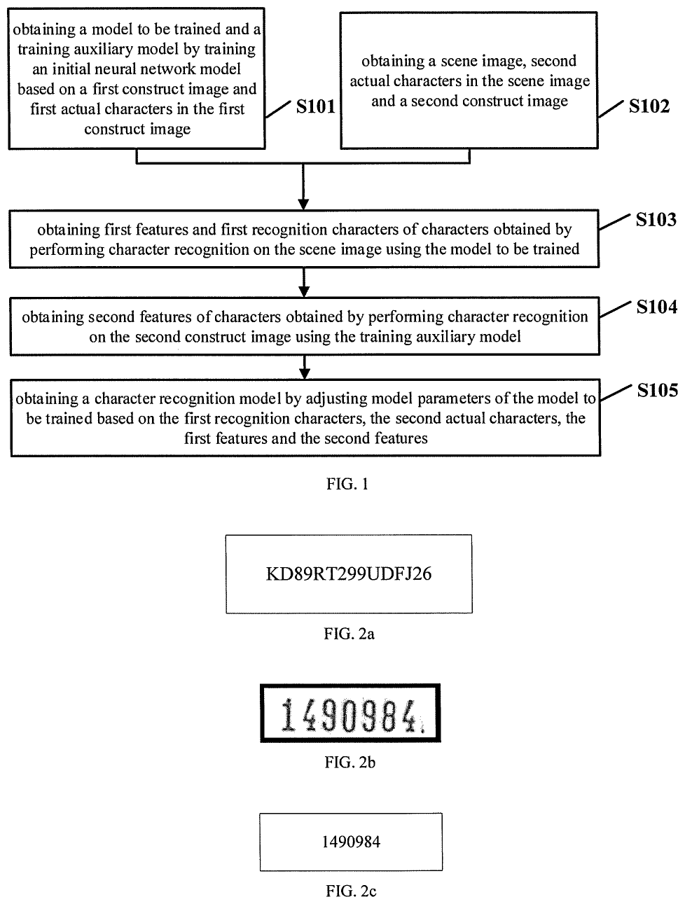

As illustrated in FIG. 1, FIG. 1 is a flowchart of a first method for training a model according to embodiments of the disclosure. The above method includes the following steps S101-S105.

At block S101, a model to be trained and a training auxiliary model are obtained by training an initial neural network model based on a first construct image and first actual characters in the first construct image.

The above first construct image refers to an image constructed artificially, rather than an image acquired by an image acquisition device for a scene. There are multiple different types of construct images for the above first construct image, and for specific types, reference should be made to images shown in FIG. 6a and FIG. 6b and the corresponding embodiments.

In a process of constructing images, various image generation algorithms can be used to construct images. The above image generation algorithms may be various algorithms for image generation in the related art, which are not limited in some embodiments of the disclosure.

The above first actual characters refer to actual characters in the first construct image. The first actual characters can be obtained all at once when constructing the first construct image.

Taking FIG. 2a as an example, FIG. 2a is a construct image, in which “KD89RT299UDFJ26” is characters actually included in the construct image, that is, the first actual characters.

The above initial neural network model may be a neural network model that has not been trained. For example, the initial neural network model may be a convolutional neural network (CNN) model, or a recurrent neural network (RNN) model.

The process of training the initial neural network model based on the first construct image and the first actual characters is called a pre-training process, and the trained initial neural network model is called a pre-trained model.

When training the initial neural network model based on the first construct image and the first actual characters, the first actual characters can be used as supervision information to carry out supervised training. In this way, the pre-trained model obtained after the supervised training learns the ability to perform character recognition on images. The process of training the initial neural network model based on the first construct image and the first actual characters can be referred to as the pre-training process. Compared with the initial neural network model that has not been pre-trained, the pre-trained model can quickly and accurately process the scene image, the second construct image, and the third construct image based on the learned character recognition ability, thereby shortening the training duration of the model to be trained and improving the training efficiency.

In addition, since the pre-trained model is trained by taking the construct image as a training sample, and the construct image can be constructed without an upper limit. Therefore, when training the initial neural network model, a large batch of first construct images can be obtained as training samples. The initial neural network model is trained based on the large batch of training samples, so that the pre-trained model obtained after the training has the better character recognition ability.

The pre-trained model can be obtained in the following two ways.

In the first implementation, the above pre-trained model may be a model obtained by pre-training, which can be directly obtained.

In the second implementation, the first construct image and the first actual characters can be obtained, and the first construct image is input into the initial neural network model to obtain the recognition characters that are output by the initial neural network model. According to the recognition characters and the first actual characters, the loss value of the initial neural network model for character recognition may be calculated. The model parameters of the initial neural network model are adjusted according to the loss value, and the above process is repeated until a first end condition is satisfied, thus the training of the initial neural network model is realized, and the pre-trained model is obtained.

The above first end condition may be that on a verification set generated by the construct images, the character recognition accuracy rate of the network model for the first construct image is close to 100%.

In detail, a parameter adjustment algorithm such as a gradient descent manner can be used to adjust the model parameters.

The model to be trained and the training auxiliary model are the same models as the pre-trained model, and the above models all have the ability to recognize characters. In an implementation, the obtained pre-trained model is used as the model to be trained, and the training auxiliary model can be obtained by copying the pre-trained model.

At block S102, a scene image, second actual characters in the scene image and a second construct image are obtained.

The scene image refers to an image obtained by image acquisition for a real scene. The real scene corresponding to the scene image is an application scene of the model obtained by training in the subsequent actual application process, so the above real scene corresponds to the application scene of the model obtained by training.

For example, if training is required to obtain a model that is applied to a road scene and capable of performing character recognition on a vehicle license plate image, the above scene image is a vehicle license plate image in the above road scene. If training is required to obtain a model that is applied to an education scene and capable of performing character recognition on a book image, the above scene image is a book image in the above education scene.

The second actual characters refer to actual characters in the scene image. The second actual characters can be obtained by manual annotation.

The second construct image refers to an image constructed artificially, rather than an image acquired by an image acquisition device for a scene.

The characters in the second construct image are the same as the second actual characters. Taking FIGS. 2b and 2c as examples, the image shown in FIG. 2b is a scene image, and the image shown in FIG. 2c is a second construct image. The scene image shown in FIG. 2b is an image obtained by image collection on an invoice in a financial scene. In the above image, “1490984” represents the number of the invoice, which is the second actual characters in the scene image. The second construct image shown in FIG. 2b includes the characters of “1490984”, which are the same as the second actual characters.

In an implementation, the scene image, actual characters in the scene image and the construct image including the actual characters are pre-stored in a database. On the basis, the scene image, the second actual characters, and the second construct image can be obtained from the database.

The above steps S101 and S102 may be performed in parallel or in series, for example, step S101 may be performed first, followed by step S102, or step S102 may be performed firstly, then step S101.

At block S103, first features and first recognition characters of characters obtained by performing character recognition on the scene image using the model to be trained are obtained.

When using the model to be trained to perform character recognition on the scene image, firstly, the scene image is input into the model to be trained, then network layer(s) in the model to be trained performs feature extraction on the characters of the scene image, and carries out character recognition according to the extracted features, to obtain a recognition result.

In detail, the network layer(s) can perform feature extraction on the characters of the scene image based on an attention mechanism.

In view of the above situation, the first features are features obtained by the model to be trained when performing the feature extraction on the characters in the scene image. The first features may be the features of each character in the scene image.

The first recognition characters are the recognition result obtained by performing character recognition on the scene image by the model to be trained.

At block S104, second features of characters obtained by performing character recognition on the second construct image using the training auxiliary model are obtained.

When the training auxiliary model carries out character recognition to the second construct image, firstly, the second construct image is input into the training auxiliary model, then the network layer(s) in the training auxiliary model carries out feature extraction on the characters of the second construct image, and perform character recognition according to the extracted features, to obtain the recognition result.

In view of the above situation, the second features are features obtained by the training auxiliary model when performing feature extraction on the characters in the second construct image.

The above steps S103 and S104 may be performed in parallel or in series, for example, step S103 may be performed first, followed by step S104, or step S103 may be performed firstly, then step S104.

At block S105, a character recognition model is obtained by adjusting model parameters of the model to be trained based on the first recognition characters, the second actual characters, the first features and the second features.

When adjusting the model parameters, the first features and the second features are used. The difference between the first features and the second features reflects the feature extraction abilities of the two models for characters in two images containing the same characters. By comparing the first features and the second features, the model to be trained can be trained to achieve comparative learning.

In the process of comparative learning, the images containing the same characters are used as basics for comparative learning, and the comparative learning is performed based on the features of the characters in the two images. Therefore, in the comparative learning in some embodiments, the judgment principle that the two images are the same, is that the characters contained in the two images are the same, that is, the images and the meanings of the images are the same. In this way, the information of the characters in the images is effectively and fully utilized compared to the judgment principle that the images are the same when the image features are the same.

In detail, when comparing the first features and the second features, feature comparison can be implemented based on the algorithm idea of Bootstrap Your Own Latent (BYOL).

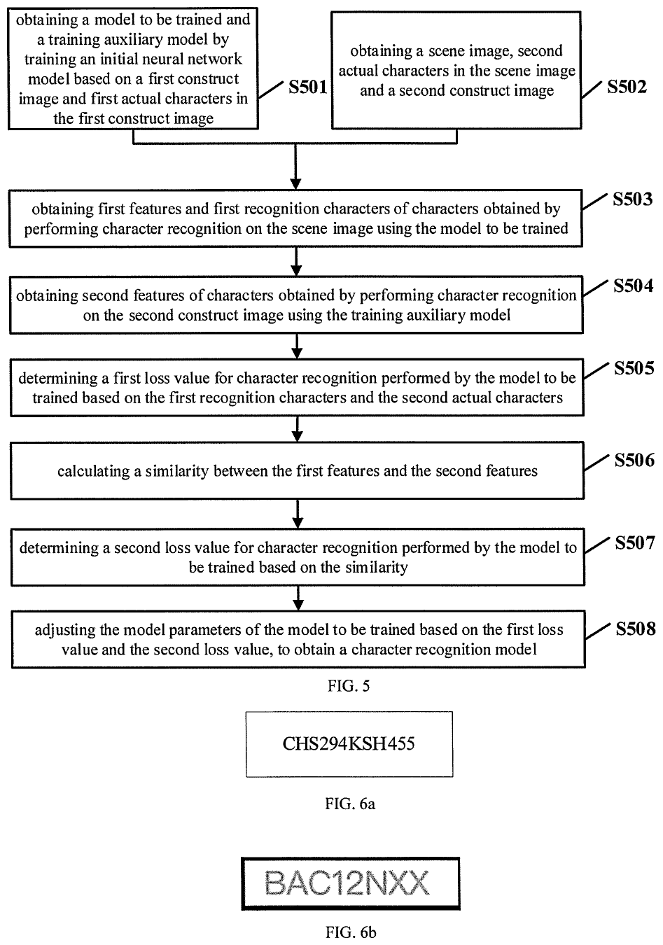

For other implementations of adjusting the model parameters, reference may be made to embodiments corresponding to FIG. 5, which will not be described in detail herein.

In the process of model training, steps S102, S103, S104 and S105 can be repeatedly performed until a second end condition is satisfied. The second end condition may be that a preset number of training times is reached, the model to be trained is converging, or the recognition accuracy of the scene image by the model to be trained is no longer increases.

As can be seen from the above, when training model according to the solutions according to embodiments of the disclosure, the model parameters of the model to be trained are adjusted based on the first recognition characters, the second actual characters, the first features and the second features, to realize the model training.

On one hand, the first recognition characters are characters obtained by performing character recognition on the scene image using the model to be trained, and the second actual characters are actual characters in the scene image. Therefore, the difference between the first recognition characters and the second actual characters can reflect the ability of the model to be trained to perform character recognition on the scene image. On the other hand, the first features are features of the characters in the scene image, extracted by the model to be trained, and the second features are features of the characters in the second construct image, extracted by the training auxiliary model. Since the training auxiliary model is obtained by training based on the construct images, the second features can accurately represent the characters in the second construct image. Moreover, since the characters in the second construct image are the same as the characters in the scene image, the difference between the first features and the second features can reflect the ability of the model to be trained to perform feature extraction on the characters in the scene image.

Based on the above two aspects, the model to be trained that is trained based on the first recognition characters, the second actual characters, the first features and the second features can not only learn the law of extracting the features of the characters in the scene image, but also learn the law of character recognition on the scene image. It can be seen that the character recognition model is obtained by training according to solutions of embodiments of the disclosure.

Since the ability of the model to be trained to extract character features affects the ability of character recognition, according to the solutions of embodiments of the disclosure, model parameter adjustment carried out from the perspective of extracting character features in the model training process, thus it is possible to improve the accuracy of character recognition of the model to be trained obtained by training.

In addition, when training the model to be trained, comparative learning is implemented based on the first features and the second features. In this process, the judgment principle for considering two images to be the same is that the characters contained are the same. Compared with the judgment principle that the images containing the same image features are the same, the information of the characters in the image is effectively and fully utilized. The interference of non-character information in the image is excluded, and the accuracy of character recognition by the model to be trained obtained by training is further improved. Furthermore, since comparative learning is introduced in the model training process, the number of negative samples required for the model training process can be reduced.

In the process of training the model to be trained, in addition to introducing the training auxiliary model to assist in the training, the model training can also be completed by multiple rounds of training, so that the model to be trained after training can more accurately perform character recognition.

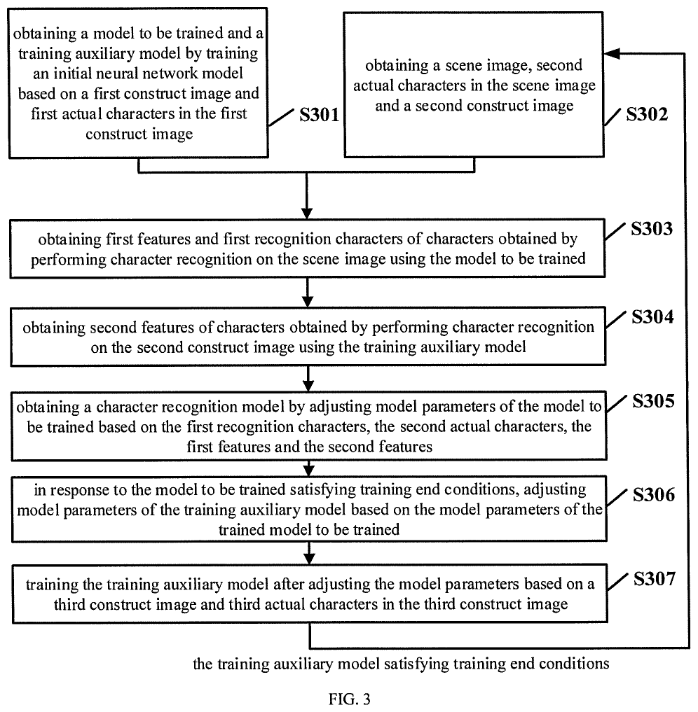

In addition, referring to FIG. 3, FIG. 3 is a flowchart of a second method for training a model according to embodiments of the disclosure. On the basis of embodiments shown in FIG. 1, after the model to be trained satisfies training end conditions, the training auxiliary model can also be trained, to make the training auxiliary model more accurate, so as to better assist the model to be trained to complete multiple rounds of model training. On the basis, the above method may further include the following steps S306-S307.

In detail, the method for training a model in some embodiments includes the following steps S301-S307.

At block S301, a model to be trained and a training auxiliary model are obtained by training an initial neural network model based on a first construct image and first actual characters in the first construct image.

At block S302, a scene image, second actual characters in the scene image and a second construct image are obtained.

The characters in the second construct image are the same as the second actual characters.

At block S303, first features and first recognition characters of characters obtained by performing character recognition on the scene image using the model to be trained are obtained.

At block S304, second features of characters obtained by performing character recognition on the second construct image using the training auxiliary model are obtained.

At block S305, a character recognition model is obtained by adjusting model parameters of the model to be trained based on the first recognition characters, the second actual characters, the first features and the second features.

Steps S301-S305 are the same as steps S101-S105 in embodiments shown in FIG. 1, and will not be described in detail herein.

At block S306, in response to the model to be trained satisfying training end conditions, model parameters of the training auxiliary model are adjusted based on the model parameters of the trained model to be trained.

Since the model to be trained after training has learned not only the law of extracting features of characters in the scene image, but also the law of character recognition on the scene image, the model parameters of the training auxiliary model are adjusted according to the model parameters of the trained model to be trained. Therefore, the training auxiliary model has the ability to extract the features of the characters in the scene image, and the ability to perform character recognition on the scene image.

In detail, the model parameters of the training auxiliary model can be adjusted in the following two different ways.

In a first implementation, the model parameters of the training auxiliary model are adjusted to the model parameters of the trained model to be trained.

In detail, the model parameters of the model to be trained after training can be copied, and the model parameters of the training auxiliary model can be adjusted to the model parameters obtained by copying.

Since the model parameters of the training auxiliary model are adjusted to the model parameter of the trained model to be trained, the model parameters of the training auxiliary model are the complete model parameters of the trained model to be trained, and the auxiliary training model also has the ability of character recognition and character feature extraction of the trained model to be trained.

In the second implementation, fusion model parameters are obtained by fusing the model parameters of the trained model to be trained and the model parameters of the training auxiliary model, and the model parameters of the training auxiliary model are adjusted to the fusion model parameters.

In detail, the model parameters of the trained model to be trained and the model parameters of the training auxiliary model can be weighted and summed according to a preset weight, as the fusion model parameters.

For example, the model parameters of the trained model to be trained are M1, the model parameters of the training auxiliary model are M2, the preset weight corresponding to the model parameters of the model to be trained is 0.8, and the preset weight corresponding to the model parameters of the training auxiliary model is 0.2, and M1 and M2 are weighted and summed to obtain (0.8*M1+0.2*M2), which is used as the fusion model parameters.

The fusion model parameters are obtained by fusing the model parameters of the trained model to be trained and the model parameters of the training auxiliary model, and the fusion model parameters are not only related to the model parameters of the model to be trained, but also related to the model parameters of the training auxiliary model. When adjusting the model parameters of the training auxiliary model based on the fusion model parameters, the adjusted parameters are relevant to the model parameters of the training auxiliary model itself, and the model parameters of the training auxiliary model do not need to be substantially adjusted, to achieve smooth transition for adjusting the above model parameters.

At block S307, the training auxiliary model is trained after adjusting the model parameters based on a third construct image and third actual characters in the third construct image; in response to the training auxiliary model satisfying training end conditions, step S302 is repeated, to retrain the model to be trained.

The third construct image may be the same image as the second construct image. In this case, the second construct image may be determined as the third construct image, and the first actual characters may be determined as the third actual characters.

The third construct image may also be an image different from the second construct image. In this case, it is necessary to obtain the third construct image and the third actual characters in the third construct image.

When obtaining the third construct image and the third actual characters, the third construct image and the third actual characters in the third construct image may be obtained from a pre-stored construct image library. An image generation algorithm may also be used to generate an image as the third construct image, and the actual characters in the generated image are determined as the third actual characters.

When training the training auxiliary model after adjusting the model parameters, the third construct image can be input into the training auxiliary model, to obtain the recognition characters that are output by the training auxiliary model. The loss value of the training auxiliary model for character recognition may be calculated according to the recognition characters and the third actual characters, and the model parameters of the training auxiliary model are adjusted according to the loss value. If the training end conditions are not satisfied, the third construct image and the third actual characters are re-obtained, and the above process is repeated until the third end conditions are satisfied, so as to realize the training of the training auxiliary model after adjusting the model parameters.

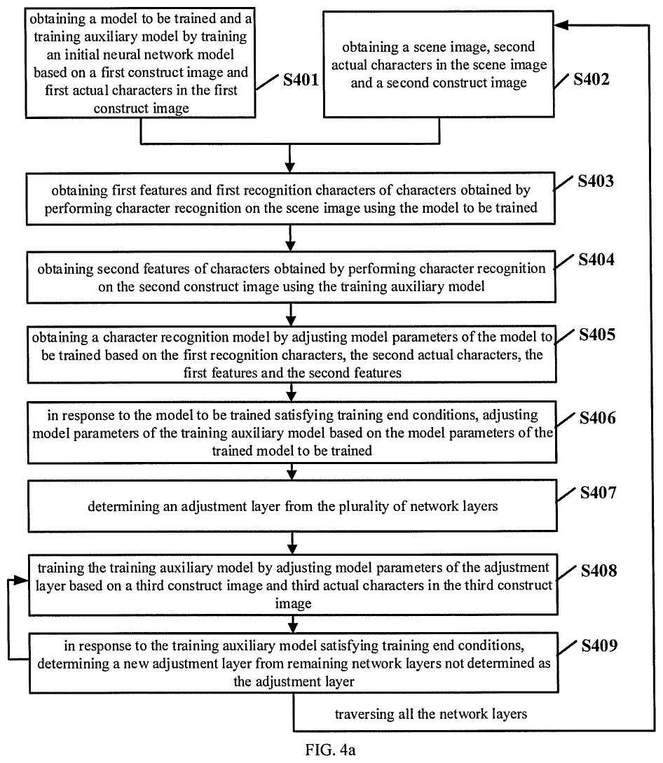

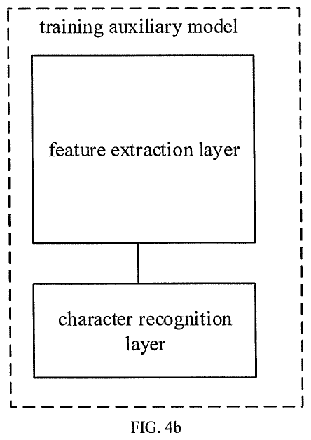

For other implementations of training the training auxiliary model, reference may be made to steps S407-S408 in embodiments shown in FIG. 4a, which will not be described in detail herein.

The third end conditions are the training end conditions mentioned in step 307. The third end conditions may be that the training auxiliary model is converging, or a preset number of training times is reached.

When the training auxiliary model satisfies the training end conditions, step S302 is executed, and steps S302-S307 are repeated, to retrain the model to be trained.

In some embodiments, the parameters of the model to be trained will be adjusted for multiple times so that the model to be trained satisfies the training end conditions, which is called a round of training.

In detail, the number of rounds can be set, and after reaching the preset number of rounds, the model to be trained after training is obtained, and the training of the model to be trained is realized. For example, the preset number may be 2 or 3.

As can be seen from the above, in the solutions in some embodiments, the model to be trained is trained for multiple rounds, and in each round of training, the parameters of the model to be trained are adjusted in multiple stages. The parameter adjustment of the latter stage is carried out on the basis of the parameter adjustment of the previous stage. Since the model to be trained after the parameter adjustment in the previous stage already has good character feature extraction ability and character recognition ability, and the training auxiliary model obtained from the previous training stage has good character feature extraction ability for the scene image and the construct image, when the model to be trained is assisted in the latter stage based on the training auxiliary model, more accurate comparison result can be obtained, which further strengthens the ability of feature extraction and character recognition of the model to be trained, and improves the accuracy of character recognition of the model to be trained.

It is understood by those skilled in the art that the neural network model generally includes network layers, and the training auxiliary model includes a plurality of network layers. In this case, in step S307, the training auxiliary model after adjusting the parameters is trained, which can be implemented according to steps S407-S409 in embodiments shown in FIG. 4a.

In detail, the method in some embodiments includes the following steps S401-S409.

At block S401, a model to be trained and a training auxiliary model are obtained by training an initial neural network model based on a first construct image and first actual characters in the first construct image.

At block S402, a scene image, second actual characters in the scene image and a second construct image are obtained.

The characters in the second construct image are the same as the second actual characters.

At block S403, first features and first recognition characters of characters obtained by performing character recognition on the scene image using the model to be trained are obtained.

At block S404, second features of characters obtained by performing character recognition on the second construct image using the training auxiliary model are obtained.

At block S405, a character recognition model is obtained by adjusting model parameters of the model to be trained based on the first recognition characters, the second actual characters, the first features and the second features.

At block S406, in response to the model to be trained satisfying training end conditions, model parameters of the training auxiliary model are adjusted based on the model parameters of the trained model to be trained.

Steps S401-S406 are the same as steps S301-S306 in embodiments shown in FIG. 3, and will not be described in detail here.

At block S407, an adjustment layer is determined from the plurality of network layers.

The adjustment layer refers to a network layer whose model parameters are currently to be adjusted.

In detail, the adjustment layer can be determined in the following two different ways.

In the first implementation, the network layer is selected as the adjustment layer according to a connection sequence among the network layers. When selecting the network layer, a preset number of network layers that have not been selected as the adjustment layer are selected according to the connection sequence each time. The preset number may be 1 or 2.

For example, assuming that the training auxiliary model includes a network layer 1, a network layer 2 and a network layer 3, and the connection sequence among the network layers is: the network layer 1→the network layer 2→the network layer 3, and the preset number is 1. According to the above connection sequence, the network layer 1 is determined as the adjustment layer for the first time, the network layer 2 is determined as the adjustment layer for the second time, and the network layer 3 is determined as the adjustment layer for the third time. Currently, if it is the second time to determine the adjustment layer, the network layer 2 is selected as the adjustment layer.

In the second implementation, a preset number of network layers are randomly selected from the network layers as the adjustment layers.

At block S408, the training auxiliary model is trained by adjusting model parameters of the adjustment layer based on a third construct image and third actual characters in the third construct image.

When training the training auxiliary model, the training is performed by adjusting the model parameters of the adjustment layer, and the adjustment layer is a part of the network layers in all the network layers included in the training auxiliary model. Therefore, each time the model parameters are adjusted, only the model parameters of some network layers are adjusted, and the model parameters of the network layers that are not determined as the adjustment layers are not adjusted. Therefore, in the solutions of some embodiments, in the process of training the training auxiliary model, the mode of adjusting the model parameters each time is: adjusting only the model parameters of part of the network layers, and keeping the model parameters of other network layers fixed.

In an implementation, the third construct image is input to the training auxiliary model after adjusting the model parameters, the recognition characters that are output by the training auxiliary model are obtained. According to the recognition characters and the third actual characters, the loss value of the training auxiliary model for character recognition may be calculated, and the model parameters of the adjustment layer are adjusted according to the loss value. In response to fourth end conditions are not satisfied, the step of obtaining the third construct image and the third actual characters is executed, and the step of inputting the third construct image into the training auxiliary model after adjusting the model parameters is repeated until the fourth end conditions are satisfied, to realize the training of the training auxiliary model.

The fourth end conditions can be: the training auxiliary model is converging, a preset number of training times is reached, and the recognition accuracy rate of the training auxiliary model for the third construct image on the verification set generated by the construct images is no longer increases or approaches 100%.

At block S409, in response to the training auxiliary model satisfying the training end conditions, a new adjustment layer is determined from remaining network layers not determined as the adjustment layer, and step S408 is repeated until all the network layers are traversed.

Moreover, another adjustment layer is determined from the network layers that have not been determined as the adjustment layer, and the adjustment layer may be determined in the same manner as step S408, which will not be repeated herein.

When the training auxiliary model satisfies the training end conditions, it means that the adjustment of the model parameters of the current adjustment layer has ended. In this case, it continues to determine the adjustment layer from the network layers that have not been determined as the adjustment layer, and adjust the model parameters of the determined adjustment layer. When all the network layers are traversed, the training of the training auxiliary model is realized. After the training of the training auxiliary model is realized, step S402 is executed, and steps S402-S405 are repeated, to realize the training of the model to be trained.

In embodiments of the disclosure, in the process of training the training auxiliary model, a learning rate can be introduced, and the training progress of the training auxiliary model can be controlled through the learning rate.

The above learning rate can be set to a value smaller than a preset learning rate threshold value. As can be seen from the above, when training the training auxiliary model after adjusting the model parameters, the mode of adjusting the model parameters each time is as follows: adjusting only the model parameters of part of the network layers, and keeping the model parameters of other network layers fixed. After adjusting the model parameters of part of the network layers, other network layers are traversed. In one traversal cycle, the model parameters are adjusted for only part of the network layers in a targeted manner, which improves the accuracy of adjusting the model parameters of part of the network layers, thereby improving the accuracy of training the training auxiliary model.

In combination with the training auxiliary model shown in FIG. 4b, the specific process of training the training auxiliary model in FIG. 4a is described in detail.

The training auxiliary model in FIG. 4b includes two network layers, namely the feature extraction layer and the character recognition layer.

The feature extraction layer is configured to perform feature extraction on characters in the input image, and the extracted features are input into the character recognition layer.

The character recognition layer is used for character recognition based on the features input by the feature extraction layer, to obtain the recognition result.

The process of training the training auxiliary model is provided as follows.

At step 1, a standard disordered character image and actual characters in the image are obtained. The standard disordered character image refers to an image whose background is a preset background and characters contained in the image are randomly combined. The preset background may be an all-white background. The standard disordered character image is a third construct image.

At step 2, the character recognition layer is determined as an adjustment layer, and the model parameters of the character recognition layer are adjusted, and the model parameters of the feature extraction layer are fixed.

In the process of adjusting the model parameters, the standard disordered character image is input into the training auxiliary model, to obtain the recognition characters that are output by the training auxiliary model. According to the recognition characters and the actual characters in the standard disordered character image, the loss value of the training auxiliary model for character recognition may be calculated, and the model parameters of the character recognition layer are adjusted according to the loss value. In response to fifth end conditions are not satisfied, the step of inputting the standard disordered character image into the training auxiliary model is repeated until the fifth end conditions are satisfied, to realize the model parameter adjustment for the character recognition layer.

At step 3, the feature extraction layer is determined as an adjustment layer, the model parameters of the feature extraction layer are adjusted, and the model parameters of the feature extraction layer adjusted after step are fixed.

In the process of adjusting the model parameters, the same mode as step 2 is adopted to realize the adjustment of the model parameters of the feature extraction layer.

Thus, the traversal of each network layer of the training auxiliary model and the adjustment of the model parameters are completed, to realize the training of the training auxiliary model.

In embodiments of the disclosure, corresponding to the above process of training the training auxiliary model, when training the model to be trained, the same training concept can also be used to train the model to be trained.

In detail, the adjustment layer is determined in the network layers included in the model to be trained. In step S405, the model to be trained is trained by adjusting the model parameters of the adjustment layer based on the first recognition characters, the second actual characters, the first features and the second features. After the model to be trained satisfies the training end conditions, the adjustment layer is determined from the network layers that have not been determined, and the step of training the model to be trained by adjusting the model parameters of the determined adjustment layer based on the first recognition characters, the second actual characters, the first features and the second features until all the network layers are traversed, so that the training of the model to be trained is realized.

In step S105 of embodiments shown in FIG. 1, the specific implementation of adjusting the model parameters of the model to be trained may refer to steps S505-S508 in FIG. 5.

In detail, the method for training a model in some embodiments includes the following steps S501-S508.

At block S501, a model to be trained and a training auxiliary model are obtained by training an initial neural network model based on a first construct image and first actual characters in the first construct image.

At block S502, a scene image, second actual characters in the scene image and a second construct image are obtained.

The characters in the second construct image are the same as the second actual characters.

At block S503, first features and first recognition characters of characters obtained by performing character recognition on the scene image using the model to be trained are obtained.

At block S504, second features of characters obtained by performing character recognition on the second construct image using the training auxiliary model are obtained.

Steps S501-S504 are the same as steps S101-S104 in embodiments shown in FIG. 1, and will not be described in detail herein.

At block S505, a first loss value for character recognition performed by the model to be trained is determined based on the first recognition characters and the second actual characters.

In embodiments, the first recognition characters and the second actual characters are used as the values of the input parameters of a first loss function to input the first loss function to obtain the first loss value calculated based on the first loss function.

The first loss function may be a cross-entropy loss function, or a perceptual loss function.

At block S506, a similarity between the first features and the second features is calculated.

In embodiments, the distance between the first features and the second features is calculated, and the above distance is converted into a similarity as the similarity between the first features and the second features.

The above distance can be a Euclidean distance, or a cosine distance.

According to a preset correspondence between the distance and the similarity, the calculated distance can be converted into the corresponding similarity.

At block S507, a second loss value for character recognition performed by the model to be trained is determined based on the similarity.

In embodiments, the actual similarity between the first features and the second features is determined, and the second loss value for character recognition by the model to be trained is determined according to the calculated similarity and the actual similarity.

Since the characters in the second construct image are the same as the second actual characters in the scene image, the features of the characters in the scene image and the features of the characters in the second construct image are actually the same.

On the basis, the actual similarity between the first features and the second features may be determined to be greater than a preset similarity, and the preset similarity may be 95% or 98%.

In detail, the calculated similarity and the actual similarity can be used as the values of the input parameters of a second loss function to input the second loss function, and the second loss value is calculated based on the second loss function. The second loss function may be a cross-entropy loss function or a perceptual loss function.

At block S508, according to the first loss value and the second loss value, the model parameters of the model to be trained are adjusted to obtain a character recognition model.

In detail, the model parameters of the model to be trained can be adjusted in the following two different ways.

In an embodiment, data fusion is performed on the first loss value and the second loss value, and the model parameters of the model to be trained are adjusted based on the fusion loss value.

In detail, according to a first weight corresponding to the first loss value and a second weight corresponding to the second loss value, the first loss value and the second loss value can be weighted and summed, the calculated loss value can be determined as the fusion loss value, and the model parameters of the model to be trained are adjusted based on the fusion loss value.

In another embodiment, the first loss value and the second loss value are adjusted, data fusion is performed on the adjusted first loss value and second loss value, and the model parameters of the model to be trained are adjusted based on the fusion loss value.

As can be seen from the above, the first loss value is determined according to the first recognition characters and the second actual characters, and the first loss value can more accurately reflect the ability of the model to be trained to perform character recognition. The second loss value is determined according to the similarity between the first features and the second features, and the second loss value can more accurately reflect the ability of the model to be trained to perform feature extraction. The model parameters of the model to be trained are adjusted based on the first loss value and the second loss value, which can not only adjust the model parameters of the model to be trained from the perspective of reflecting the ability of the model to be trained to perform character recognition, but also adjust the model parameters of the model to be trained from the perspective of reflecting the ability of the model to be trained to perform character recognition, so that the adjusted parameters of the model to be trained have the higher comprehensive ability and the accuracy of character recognition of the model to be trained is improved.

The first construct images of embodiments shown in FIG. 1 may include multiple different types of construct images, and the construct images included in the first construct images will be described be low.

In embodiments of the disclosure, the first construct image may include at least one of the following two images.

The first type of the first construct image is a construct image not including a scene background but including characters that do not belong to scene corpus.

The image not including the scene background means: the image background is not the background of the application scene. For example, the background of the application scene has shading. When the background of the image is all white or all black, the background is not the background of the application scene, so the image does not include the scene background.

The characters that do not belong to the scene corpus means: the characters that do not belong to the application scene. For example, the characters in the application scene are arranged according to a preset rule. When the characters in the image are randomly combined characters, the characters are not characters in the application scene. Therefore, the characters contained in the image do not belong to the scene corpus.

Taking FIG. 6a as an example, the image shown in FIG. 6a is a construct image. The image background is all white, which is not the scene of the application scene, so the image does not have the scene background. The characters contained in the image are randomly combined, which are not the characters in the application scene, so the characters contained in the image do not belong to the scene corpus.

When the construct image is a construct image not including the scene background but including characters that do not belong to the scene corpus, and when constructing the above image, it is not necessary to consider too much information, and a large number of images can be quickly constructed in a short time, so that the efficiency of constructing image can be improved.

On this basis, since there are sufficient images as training samples are used to train the model, the model can be trained well, so that a model having a strong character recognition ability can be obtained.

The second type of the first construct image is a construct image including the scene background and characters that do not belong to the scene corpus.

The image including the scene background means: the image background is the scene of the application scene. For example, if the background of the application scene has shading, and when the background of the image has shading, it means that the background is the background of the application scene.

The background of the construct image may be the background similar to the background of the scene image. In this way, when the model is pre-trained based on the above construct image, the model can learn the rules of character recognition for similar background images, and in subsequent model training, the model can quickly learn the rules of character recognition for the scene image.

Taking FIG. 6b as an example, the image shown in FIG. 6b is a construct image. In the above image, the background is a scene of an invoice image in the financial scene, which has the scene background. The characters contained in the image are randomly combined, which are not the characters in the invoice image in the financial scene.

When the construct image is used to pre-train the model, since the construct image is the construct image including the scene background but including characters that do not belong to the scene corpus, the pre-trained model has the ability to recognize the characters in the image having the scene background, in the subsequent model training, it can quickly learn how to recognize the rules of characters in the scene image.

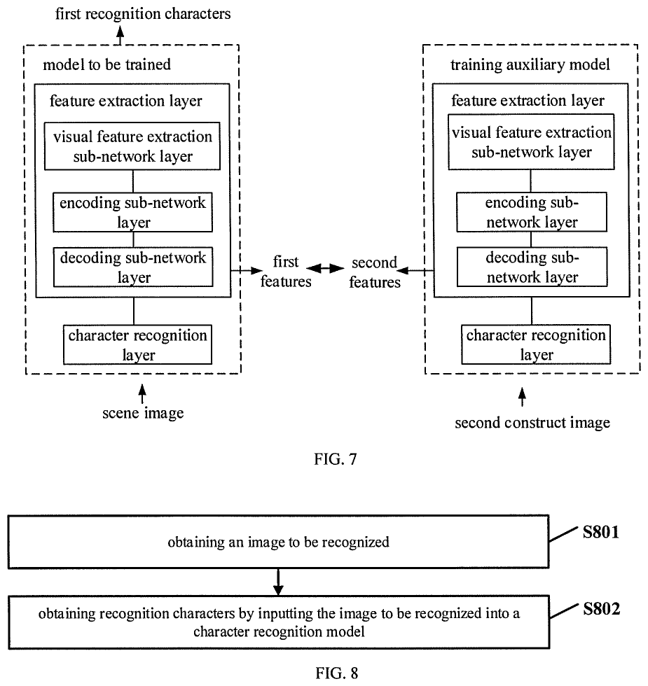

The following describes the method for training a model of embodiments of the disclosure in combination with the model structure diagram shown in FIG. 7.

In FIG. 7, two models are included, and the left model is the model to be trained, and the right model is the training auxiliary model. The model to be trained and the training auxiliary model are the same model, which are the same as the pre-trained model obtained by pre-training the initial neural network model.

The model to be trained and the training auxiliary model all include a feature extraction layer and a character recognition layer.

The feature extraction layer is configured to perform feature extraction on characters in the input image, and input the extracted features into the character recognition layer.

The character recognition layer is configured for character recognition based on the input features to obtain recognized characters.

The feature extraction layer includes a visual feature extraction sub-network layer, an encoding sub-network layer, and a decoding sub-network layer.

The visual feature extraction sub-network layer is configured to convert the input image into a highly-abstracted feature sequence, and input the obtained feature sequence into an encoding unit. The visual feature extraction unit can convert the feature sequence based on Residual Network (ResNet) structure. Further, when converting the input image into the feature sequence, the input image can be corrected firstly, the image of poor quality or scale-distorted image can be corrected into the image of high quality or the image including straightly-arranged text.

The encoding sub-network layer is configured to strengthen a semantic connection among visual features, obtain semantic information of the characters in the image, and input the obtained semantic information to the decoding unit. The encoding unit can strengthen the semantic connection based on the RNN network structure.

The decoding sub-network layer is configured to convert the semantic information into text that can be understood by the computer, and obtain the features of the characters in the image. The decoding unit may be based on the connectionist temporal classification (CTC) algorithm or the attention mechanism.

When training the model to be trained, the first step is to input the scene image into the model to be trained, and input the second construct image into the training auxiliary model.

The actual characters included in the scene image are the same as the actual characters included in the second construct image.

In the second step, the first recognition characters that are output by the model to be trained, the first features that are output by the feature extraction layer in the model to be trained, and the second features that are output by the feature extraction layer in the training auxiliary model are obtained.

In the third step, according to the actual characters included in the first recognition characters, the scene image, the first features and the second features, the model parameters of the model to be trained are adjusted, and if the training end conditions are not satisfied, the first step is repeated until the training end conditions are satisfied.

In the fourth step, the model parameters of the training auxiliary model are adjusted according to the model parameters of the trained model to be trained.

In the fifth step, the training auxiliary model after adjusting the parameters is trained based on the third construct image and the third actual characters in the third construct image.

In the sixth step, after the training auxiliary model satisfies the training end conditions, the first step is executed and the model to be trained is retrained.

Corresponding to the method for training a model, the disclosure also provides a method for recognizing characters.

Referring to FIG. 8, FIG. 8 is a flowchart of a method for recognizing characters according to embodiments of the disclosure, and the method includes the following steps S801-S802.

At block S801, an image to be recognized is obtained.

At block S802, the image to be recognized is input into a character recognition model, to obtain recognized characters that are output by the character recognition model.

The character recognition model is a model obtained by training according to the method for training a model according to embodiments of the disclosure.

As can be seen from the above, when character recognition is performed according to the solutions of embodiments of the disclosure, since the character recognition model is obtained by model training using a large number of scene images and construct images as training samples, the character recognition model has an excellent ability to recognize characters in an image, so that when using the character recognition model, the characters in the image to be recognized can be more accurately recognized.

Corresponding to the method for training a model, embodiments of the disclosure provides an apparatus for training a model.

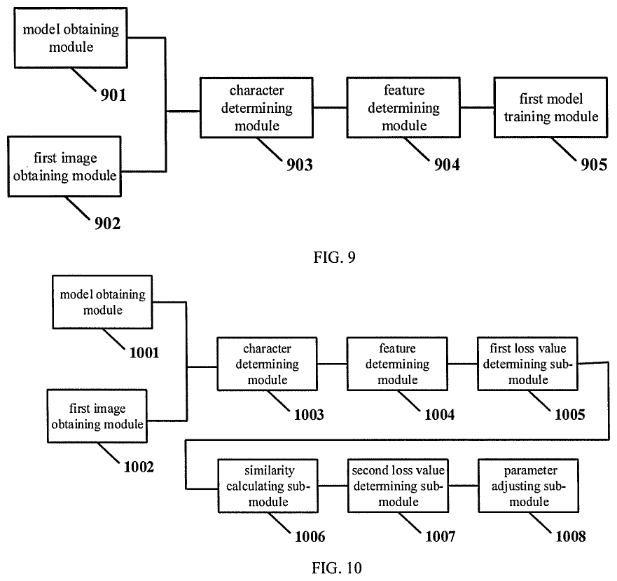

Referring to FIG. 9, FIG. 9 is a schematic diagram of a first apparatus for training a model according to embodiments of the disclosure, and the above apparatus includes: a model obtaining module 901, a first image obtaining module 902, a character determining module 903, a feature determining module 904 and a first model training module 905.

The model obtaining module 901 is configured to obtain a model to be trained and a training auxiliary model by training an initial neural network model based on a first construct image and first actual characters in the first construct image.

The first image obtaining module 902 is configured to obtain a scene image, second actual characters in the scene image and a second construct image, in which characters in the second construct image are identical to the second actual characters.

The character determining module 903 is configured to obtain first features and first recognition characters of characters obtained by performing character recognition on the scene image using the model to be trained.

The feature determining module 904 is configured to obtain second features of characters obtained by performing character recognition on the second construct image using the training auxiliary model.

The first model training module 905 is configured to obtain a character recognition model by adjusting model parameters of the model to be trained based on the first recognition characters, the second actual characters, the first features and the second features.

As can be seen from the above, when training model according to the solutions according to embodiments of the disclosure, the model parameters of the model to be trained are adjusted based on the first recognition characters, the second actual characters, the first features and the second features, to realize the model training.

On one hand, the first recognition characters are characters obtained by performing character recognition on the scene image using the model to be trained, and the second actual characters are actual characters in the scene image. Therefore, the difference between the first recognition characters and the second actual characters can reflect the ability of the model to be trained to perform character recognition on the scene image. On the other hand, the first features are features of the characters in the scene image, extracted by the model to be trained, and the second features are features of the characters in the second construct image, extracted by the training auxiliary model. Since the training auxiliary model is obtained by training based on the construct images, the second features can accurately represent the characters in the second construct image. Moreover, since the characters in the second construct image are the same as the characters in the scene image, the difference between the first features and the second features can reflect the ability of the model to be trained to perform feature extraction on the characters in the scene image.

Based on the above two aspects, the model to be trained that is trained based on the first recognition characters, the second actual characters, the first features and the second features can not only learn the law of extracting the features of the characters in the scene image, but also learn the law of character recognition on the scene image. It can be seen that the character recognition model is obtained by training according to solutions of embodiments of the disclosure.

Referring to FIG. 10, FIG. 10 is a schematic diagram of a second apparatus for training a model according to embodiments of the disclosure. The above apparatus includes: a model obtaining module 1001, a first image obtaining module 1002, a character determining module 1003, a feature determining module 1004, a first loss value determining sub-module 1005, a similarity calculating sub-module 1006, a second loss value determining sub-module 1007 and a parameter adjusting sub-module 1008.

The model obtaining module 1001 is configured to obtain a model to be trained and a training auxiliary model by training an initial neural network model based on a first construct image and first actual characters in the first construct image.

The first image obtaining module 1002 is configured to obtain a scene image, second actual characters in the scene image and a second construct image, in which characters in the second construct image are identical to the second actual characters.

The character determining module 1003 is configured to obtain first features and first recognition characters of characters obtained by performing character recognition on the scene image using the model to be trained.

The feature determining module 1004 is configured to obtain second features of characters obtained by performing character recognition on the second construct image using the training auxiliary model.

The first loss value determining sub-module 1005 is configured to determine a first loss value for character recognition performed by the model to be trained based on the first recognition characters and the second actual characters.

The similarity calculating sub-module 1006 is configured to calculate a similarity between the first features and the second features.

The second loss value determining sub-module 1007 is configured to determine a second loss value for character recognition performed by the model to be trained based on the similarity.

The parameter adjusting sub-module 1008 is configured to adjust the model parameters of the model to be trained based on the first loss value and the second loss value, to obtain the character recognition model.

As can be seen from the above, the first loss value is determined based on the first recognition characters and the second actual characters, and the first loss value can more accurately reflect the ability of the model to be trained to perform character recognition. The second loss value is determined according to the similarity between the first features and the second features, and the second loss value can more accurately reflect the ability of the model to be trained to perform feature extraction. The model parameters of the model to be trained are adjusted based on the first loss value and the second loss value, which can not only adjust the model parameters of the model to be trained from the perspective of reflecting the ability of the model to be trained to perform character recognition, but also adjust the model parameters of the model to be trained from the perspective of reflecting the ability of the model to be trained to perform character recognition, so that the adjusted parameters of the model to be trained have a higher comprehensive ability and the accuracy of character recognition of the model to be trained is improved.

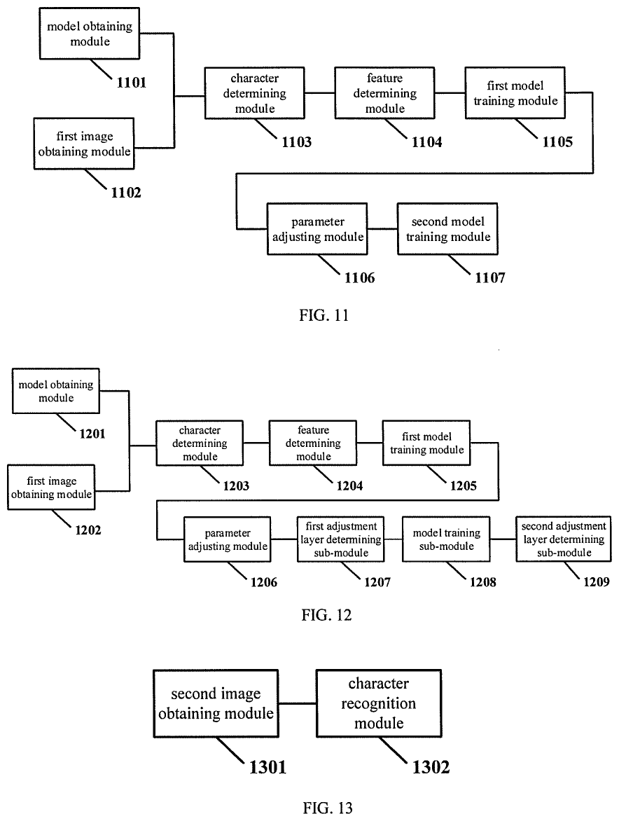

Referring to FIG. 11, FIG. 11 is a schematic diagram of a third apparatus for training a model according to embodiments of the disclosure. The above apparatus includes: a model obtaining module 1101, a first image obtaining module 1102, a character determining module 1103, a feature determining module 1104, a first model training module 1105, a parameter adjusting sub-module 1106 and a second model training module 1107.

The model obtaining module 1101 is configured to obtain a model to be trained and a training auxiliary model by training an initial neural network model based on a first construct image and first actual characters in the first construct image.

The first image obtaining module 1102 is configured to obtain a scene image, second actual characters in the scene image and a second construct image, in which characters in the second construct image are identical to the second actual characters.

The character determining module 1103 is configured to obtain first features and first recognition characters of characters obtained by performing character recognition on the scene image using the model to be trained.

The feature determining module 1104 is configured to obtain second features of characters obtained by performing character recognition on the second construct image using the training auxiliary model.

The first model training module 1105 is configured to obtain a character recognition model by adjusting model parameters of the model to be trained based on the first recognition characters, the second actual characters, the first features and the second features.

The parameter adjusting module 1106 is configured to, in response to the model to be trained satisfying training end conditions, adjust model parameters of the training auxiliary model based on the model parameters of the trained model to be trained.

The second model training module 1107 is configured to train the training auxiliary model after adjusting the model parameters based on a third construct image and third actual characters in the third construct image, and in response to the training auxiliary model satisfying the training end conditions, trigger the first image obtaining module to retrain the model to be trained.

As can be seen from the above, in the solutions in some embodiments, the model to be trained is trained for multiple rounds, and in each round of training, the parameters of the model to be trained are adjusted in multiple stages. The parameter adjustment of the latter stage is carried out on the basis of the parameter adjustment of the previous stage. Since the model to be trained after the parameter adjustment in the previous stage already has good character feature extraction ability and character recognition ability, and the training auxiliary model obtained from the previous training stage has good character feature extraction ability for the scene image and the construct image, when the model to be trained is assisted in the latter stage based on the training auxiliary model, more accurate comparison result can be obtained, which further strengthens the ability of feature extraction and character recognition of the model to be trained, and improves the accuracy of character recognition of the model to be trained.

Referring to FIG. 12, FIG. 12 is a schematic diagram of a fourth apparatus for training a model according to embodiments of the disclosure. The training auxiliary model includes multiple network layers, the module 1107 includes: a model obtaining module 1201, a first image obtaining module 1202, a character determining module 1203, a feature determining module 1204, a first model training module 1205, a parameter adjusting module 1206, a first adjustment layer determining sub-module 1207, a model training sub-module 1208 and a second adjustment layer determining sub-module 1209.

The model obtaining module 1201 is configured to obtain a model to be trained and a training auxiliary model by training an initial neural network model based on a first construct image and first actual characters in the first construct image.

The first image obtaining module 1202 is configured to obtain a scene image, second actual characters in the scene image and a second construct image, in which characters in the second construct image are identical to the second actual characters.

The character determining module 1203 is configured to obtain first features and first recognition characters of characters obtained by performing character recognition on the scene image using the model to be trained.

The feature determining module 1204 is configured to obtain second features of characters obtained by performing character recognition on the second construct image using the training auxiliary model.

The first model training module 1205 is configured to obtain a character recognition model by adjusting model parameters of the model to be trained based on the first recognition characters, the second actual characters, the first features and the second features.

The parameter adjusting module 1206 is configured to, in response to the model to be trained satisfying training end conditions, adjust model parameters of the training auxiliary model based on the model parameters of the trained model to be trained.

The first adjustment layer determining sub-module 1207 is configured to determine an adjustment layer from the plurality of network layers.

The model training sub-module 1208 is configured to train the training auxiliary model by adjusting model parameters of the adjustment layer based on the third construct image and the third actual characters in the third construct image.

The second adjustment layer determining sub-module 1209 is configured to, in response to the training auxiliary model satisfying training end conditions, determine a new adjustment layer from remaining network layers not determined as the adjustment layer, and trigger the model training sub-module until all the network layers are traversed.

As can be seen from the above, when training the training auxiliary model after adjusting the model parameters, the mode of adjusting the model parameters each time is as follows: adjusting only the model parameters of part of the network layers, and keeping the model parameters of other network layers fixed. After adjusting the model parameters of part of the network layers, other network layers are traversed. In one traversal cycle, the model parameters are adjusted for only part of the network layers in a targeted manner, which improves the accuracy of adjusting the model parameters of part of the network layers, thereby improving the accuracy of training the training auxiliary model.

In embodiments of the disclosure, the parameter adjusting module is further configured to: adjust the model parameters of the training auxiliary model to the model parameters of the trained model to be trained; or, obtain fusion model parameters by fusing the model parameters of the trained model to be trained and the model parameters of the training auxiliary model, and adjust the model parameters of the training auxiliary model to the fusion model parameters.

Since the model parameters of the training auxiliary model are adjusted to the model parameters of the trained model to be trained, the model parameters of the training auxiliary model are complete model parameters of the model to be trained after training, so the training auxiliary model also has the ability of character recognition and character feature extraction of the model to be trained after training. Moreover, the fusion model parameters are obtained by fusing the model parameters of the trained model to be trained and the model parameters of the training auxiliary model, the fusion model parameters are not only related to the model parameters of the model to be trained, but also related to the model parameters of the training auxiliary model. When the model parameters of the training auxiliary model are adjusted based on the fusion model parameters, the adjusted parameters are related to the model parameters of the training auxiliary model itself, and there is no need to adjust the model parameters of the training auxiliary model significantly, to realize the smooth transition of model parameter adjustment.

In embodiments of the disclosure, the first construct image includes at least one of the following images: a construct image not including a scene background but including characters that do not belong to scene corpus; and a construct image including a scene background and characters that do not belong to the scene corpus.

When the construct image is a construct image not including a scene background but including characters that do not belong to scene corpus, when constructing the above image, it is not necessary to consider too much information, and a large number of images can be quickly constructed in a short time, thus the efficiency of constructing images can be improved.

On the basis, since there are sufficient images as training samples to train the model, the model can be trained well, so that a model with strong character recognition ability can be obtained.

When the construct image is a construct image including a scene background and characters that do not belong to the scene corpus, when using the construct image to pre-train the model, the model obtained by pre-training has the ability to recognize characters in the image having a scene background, in the subsequent model training, it can quickly learn how to recognize the rules of characters in the scene image.

Corresponding to the above method for recognizing characters, embodiments of the disclosure provides an apparatus for recognizing characters.

Referring to FIG. 13, FIG. 13 is a schematic diagram of an apparatus for recognizing characters according to embodiments of the disclosure, and the above apparatus includes: a second image obtaining module 1301 and a character recognition module 1302.

The second image obtaining module 1301 is configured to obtain an image to be recognized.

The character recognition module 1302 is configured to obtain recognition characters by inputting the image to be recognized into a character recognition model, in which the character recognition model is a model trained based on the apparatus for training a model.

As can be seen from the above, when character recognition is performed according to the solution of embodiments of the disclosure, since the character recognition model is obtained by model training using a large number of scene images and construct images as training samples, the character recognition model has an excellent ability to recognize characters in an image, so that when using the character recognition model, the characters in the image to be recognized can be more accurately recognized.

In the technical solution of the disclosure, collection, storage, use, processing, transmission, provision and disclosure of the user's personal information involved are all in compliance with relevant laws and regulations, and do not violate public order and good customs.

According to embodiments of the disclosure, the disclosure also provides an electronic device, a readable storage medium, and a computer program product.

According to embodiments of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is enabled to implement the method for training a model or the method for recognizing characters.

According to embodiments of the disclosure, a non-transitory computer-readable storage medium storing computer instructions is provided. The computer instructions are configured to cause a computer to implement the method for training a model or the method for recognizing characters.

According to embodiments of the disclosure, a computer program product including computer programs is provided. When the computer programs are executed by a processor, the method for training a model or the method for recognizing characters is implemented.

It can be seen from the above, when model training is performed according to solutions of embodiments of the disclosure, model training is realized by adjusting the model parameters of the model to be trained based on the first recognition characters, the second actual characters, the first features, and the second features.

On one hand, the first recognition characters are characters obtained by performing character recognition on the scene image using the model to be trained, and the second actual characters are actual characters in the scene image. Therefore, the difference between the first recognition characters and the second actual characters can reflect the ability of the model to be trained to perform character recognition on the scene image. On the other hand, the first features are features of the characters in the scene image, extracted by the model to be trained, and the second features are features of the characters in the second construct image, extracted by the training auxiliary model. Since the training auxiliary model is obtained by training based on the construct images, the second features can accurately represent the characters in the second construct image. Moreover, since the characters in the second construct image are the same as the characters in the scene image, the difference between the first features and the second features can reflect the ability of the model to be trained to perform feature extraction on the characters in the scene image.

Based on the above two aspects, the model to be trained that is trained based on the first recognition characters, the second actual characters, the first features and the second features can not only learn the law of extracting the features of the characters in the scene image, but also learn the law of character recognition on the scene image. It can be seen that the character recognition model is obtained by training according to solutions of embodiments of the disclosure.

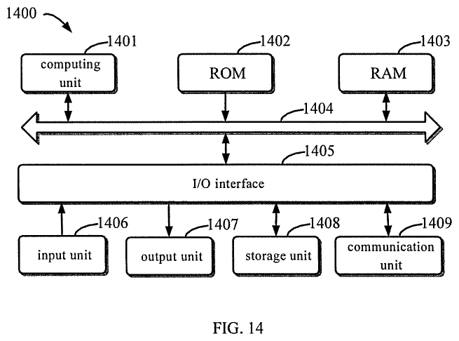

FIG. 14 is a block diagram of an example electronic device 1400 used to implement embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 14, the electronic device 1400 includes: a computing unit 1401 performing various appropriate actions and processes based on computer programs stored in a read-only memory (ROM) 1402 or computer programs loaded from the storage unit 1408 to a random access memory (RAM) 1403. In the RAM 1403, various programs and data required for the operation of the device 1400 are stored. The computing unit 1401, the ROM 1402, and the RAM 1403 are connected to each other through a bus 1404. An input/output (I/O) interface 1405 is also connected to the bus 1404.

Components in the device 1400 are connected to the I/O interface 1405, including: an inputting unit 1406, such as a keyboard, a mouse; an outputting unit 1407, such as various types of displays, speakers; a storage unit 1408, such as a disk, an optical disk; and a communication unit 1409, such as network cards, modems, and wireless communication transceivers. The communication unit 1409 allows the device 1400 to exchange information/data with other devices through a computer network such as the Internet and/or various telecommunication networks.

The computing unit 1401 may be various general-purpose and/or dedicated processing components with processing and computing capabilities. Some examples of computing unit 1401 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 1401 executes the various methods and processes described above, such as the method for training a model or the method for recognizing characters. For example, in some embodiments, the method for training a model or the method for recognizing characters may be implemented as a computer software program, which is tangibly contained in a machine-readable medium, such as the storage unit 1408. In some embodiments, part or all of the computer program may be loaded and/or installed on the device 1400 via the ROM 1402 and/or the communication unit 1409. When the computer program is loaded on the RAM 1403 and executed by the computing unit 1401, one or more steps of the method for training a model or the method for recognizing characters described above may be executed. Alternatively, in other embodiments, the computing unit 1401 may be configured to perform the method for training a model or the method for recognizing characters in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

1. A method for training a model, comprising:
obtaining a model to be trained and a training auxiliary model by training an initial neural network model based on a first construct image and first actual characters in the first construct image;
obtaining a scene image, second actual characters in the scene image and a second construct image, wherein characters in the second construct image are identical to the second actual characters;
obtaining first features and first recognition characters of characters obtained by performing character recognition on the scene image using the model to be trained;
obtaining second features of characters obtained by performing character recognition on the second construct image using the training auxiliary model; and
obtaining a character recognition model by adjusting model parameters of the model to be trained based on the first recognition characters, the second actual characters, the first features and the second features.

2. The method of claim 1, wherein adjusting the model parameters of the model to be trained based on the first recognition characters, the second actual characters, the first features and the second features, comprises:
determining a first loss value for character recognition performed by the model to be trained, based on the first recognition characters and the second actual characters;
calculating a similarity between the first features and the second features;
determining a second loss value for character recognition performed by the model to be trained, based on the similarity; and
adjusting the model parameters of the model to be trained based on the first loss value and the second loss value.

3. The method of claim 1, further comprising:
in response to the model to be trained satisfying training end conditions, adjusting model parameters of the training auxiliary model based on the model parameters of the trained model to be trained;
training the training auxiliary model after adjusting the model parameters based on a third construct image and third actual characters in the third construct image; and
in response to the training auxiliary model satisfying training end conditions, returning to the step of obtaining the scene image, the second actual characters in the scene image and the second construct image, and retraining the model to be trained.

4. The method of claim 3, wherein the training auxiliary model comprises a plurality of network layers, and training the training auxiliary model after adjusting the model parameters based on the third construct image and the third actual characters in the third construct image, comprises:
determining an adjustment layer from the plurality of network layers;
training the training auxiliary model by adjusting model parameters of the adjustment layer based on the third construct image and the third actual characters in the third construct image; and
in response to the training auxiliary model satisfying the training end conditions, determining a new adjustment layer from remaining network layers not determined as the adjustment layer, and returning to the step of training the training auxiliary model by adjusting the model parameters of the adjustment layer based on the third construct image and the third actual characters in the third construct image until all the network layers are traversed.

5. The method of claim 3, wherein adjusting the model parameters of the training auxiliary model based on the model parameters of the trained model to be trained, comprises:
adjusting the model parameters of the training auxiliary model to the model parameters of the trained model to be trained;
or,
obtaining fusion model parameters by fusing the model parameters of the trained model to be trained and the model parameters of the training auxiliary model, and adjusting the model parameters of the training auxiliary model to the fusion model parameters.

6. The method of claim 1, wherein the first construct image comprises at least one of the following images:
a construct image not including a scene background but including characters that do not belong to scene corpus; and
a construct image including a scene background and characters that do not belong to the scene corpus.

7. The method of claim 1, further comprising:
obtaining an image to be recognized; and
obtaining recognition characters by inputting the image to be recognized into the character recognition model.

8. An electronic device, comprising:
a processor; and
a memory communicatively coupled to the processor; wherein,
the memory is configured to store instructions executable by the processor, and when the instructions are executed by the processor, the is configured to:
obtain a model to be trained and a training auxiliary model by training an initial neural network model based on a first construct image and first actual characters in the first construct image;
obtain a scene image, second actual characters in the scene image and a second construct image, wherein characters in the second construct image are identical to the second actual characters;
obtain first features and first recognition characters of characters obtained by performing character recognition on the scene image using the model to be trained;
obtain second features of characters obtained by performing character recognition on the second construct image using the training auxiliary model; and
obtain a character recognition model by adjusting model parameters of the model to be trained based on the first recognition characters, the second actual characters, the first features and the second features.

9. The device of claim 8, wherein the processor is configured to:
determine a first loss value for character recognition performed by the model to be trained, based on the first recognition characters and the second actual characters;
calculate a similarity between the first features and the second features;
determine a second loss value for character recognition performed by the model to be trained, based on the similarity; and
adjust the model parameters of the model to be trained based on the first loss value and the second loss value.

10. The device of claim 8, wherein the processor is configured to:
in response to the model to be trained satisfying training end conditions, adjust model parameters of the training auxiliary model based on the model parameters of the trained model to be trained;
train the training auxiliary model after adjusting the model parameters based on a third construct image and third actual characters in the third construct image; and
in response to the training auxiliary model satisfying training end conditions, return to obtain the scene image, the second actual characters in the scene image and the second construct image, and retrain the model to be trained.

11. The device of claim 10, wherein the training auxiliary model comprises a plurality of network layers, and the processor is configured to:
determine an adjustment layer from the plurality of network layers;
train the training auxiliary model by adjusting model parameters of the adjustment layer based on the third construct image and the third actual characters in the third construct image; and
in response to the training auxiliary model satisfying the training end conditions, determine a new adjustment layer from remaining network layers not determined as the adjustment layer, and return to train the training auxiliary model by adjusting the model parameters of the adjustment layer based on the third construct image and the third actual characters in the third construct image until all the network layers are traversed.

12. The device of claim 10, wherein the processor is configured to:
adjust the model parameters of the training auxiliary model to the model parameters of the trained model to be trained;
or,
obtain fusion model parameters by fusing the model parameters of the trained model to be trained and the model parameters of the training auxiliary model, and adjusting the model parameters of the training auxiliary model to the fusion model parameters.

13. The device of claim 8, wherein the first construct image comprises at least one of the following images:
a construct image not including a scene background but including characters that do not belong to scene corpus; and
a construct image including a scene background and characters that do not belong to the scene corpus.

14. The device of claim 8, wherein the processor is configured to:
obtain an image to be recognized; and
obtain recognition characters by inputting the image to be recognized into the character recognition model.

15. A non-transitory computer-readable storage medium having computer instructions stored thereon, wherein the computer instructions are configured to cause a computer to implement a method for training a model, comprising:
obtaining a model to be trained and a training auxiliary model by training an initial neural network model based on a first construct image and first actual characters in the first construct image;
obtaining a scene image, second actual characters in the scene image and a second construct image, wherein characters in the second construct image are identical to the second actual characters;
obtaining first features and first recognition characters of characters obtained by performing character recognition on the scene image using the model to be trained;
obtaining second features of characters obtained by performing character recognition on the second construct image using the training auxiliary model; and
obtaining a character recognition model by adjusting model parameters of the model to be trained based on the first recognition characters, the second actual characters, the first features and the second features.

16. The non-transitory computer-readable storage medium of claim 15, wherein adjusting the model parameters of the model to be trained based on the first recognition characters, the second actual characters, the first features and the second features, comprises:
determining a first loss value for character recognition performed by the model to be trained, based on the first recognition characters and the second actual characters;
calculating a similarity between the first features and the second features;
determining a second loss value for character recognition performed by the model to be trained, based on the similarity; and
adjusting the model parameters of the model to be trained based on the first loss value and the second loss value.

17. The non-transitory computer-readable storage medium of claim 15, wherein the method further comprises:
in response to the model to be trained satisfying training end conditions, adjusting model parameters of the training auxiliary model based on the model parameters of the trained model to be trained;
training the training auxiliary model after adjusting the model parameters based on a third construct image and third actual characters in the third construct image; and
in response to the training auxiliary model satisfying training end conditions, returning to the step of obtaining the scene image, the second actual characters in the scene image and the second construct image, and retraining the model to be trained.

18. The non-transitory computer-readable storage medium of claim 17, wherein the training auxiliary model comprises a plurality of network layers, and training the training auxiliary model after adjusting the model parameters based on the third construct image and the third actual characters in the third construct image, comprises:
determining an adjustment layer from the plurality of network layers;
training the training auxiliary model by adjusting model parameters of the adjustment layer based on the third construct image and the third actual characters in the third construct image; and
in response to the training auxiliary model satisfying the training end conditions, determining a new adjustment layer from remaining network layers not determined as the adjustment layer, and returning to the step of training the training auxiliary model by adjusting the model parameters of the adjustment layer based on the third construct image and the third actual characters in the third construct image until all the network layers are traversed.

19. The non-transitory computer-readable storage medium of claim 17, wherein adjusting the model parameters of the training auxiliary model based on the model parameters of the trained model to be trained, comprises:
adjusting the model parameters of the training auxiliary model to the model parameters of the trained model to be trained;
or,
obtaining fusion model parameters by fusing the model parameters of the trained model to be trained and the model parameters of the training auxiliary model, and adjusting the model parameters of the training auxiliary model to the fusion model parameters.

20. The non-transitory computer-readable storage medium of claim 15, wherein the method further comprises:
obtaining an image to be recognized; and
obtaining recognition characters by inputting the image to be recognized into the character recognition model.
